(19) United States
(12) Patent Application Publication
(10) Pub. No.: US 2016/0342177 A1
(43) Pub. Date: Nov. 24, 2016

(54) Screen Attachment in a Portable Electronic Device

(71) Applicant: Motorola Mobility LLC, Chicago, IL (US)

(72) Inventors: David K. Lim, Glenview, IL (US); Joseph Allore, Mundelein, IL (US); Michael J. Lombardi, Lake Zurich, IL (US)

(21) Appl. No.: 14/716,950

(22) Filed: May 20, 2015

(51) Int. Cl. G06F 1/16

(52) U.S. Cl. CPC G06F 1/1626

(57) ABSTRACT

A high-efficiency mounting system is provided for attaching the lens and display of a portable electronic device. The described mounting system uses a three-layer adhesive system to provide a product having minimal borders outside of the display area while also providing the ability to remove the display assembly without damaging it, allowing reworkability of one of the most expensive parts of the device.

### TECHNICAL FIELD

The present disclosure is related generally to mobile electronic devices, and, more particularly, to a system and method for display screen attachment in such a device.

### BACKGROUND

Even as the average smartphone shrinks in size each year, smartphone display screens are staying about the same size, or even growing. One reason for this is that the required screen size is dictated by unchanging human factors such as eyesight, finger size and so on.

Beyond meeting these practical limitations, modern cell phone screens also embody many sources of inefficiency that increase device size beyond what is needed, while also decreasing strength and reparability. For example, a typical modern display assembly includes the active display as well as a lens on top of the display. Present day cell phones typically have a standard adhesive border on the lens beyond the active display, adding to the product's height and width. This adhesive lens border is generally required since the use of known techniques to adhere the display itself to the device housing would damage the display and cause reworkability issues. With the display being one of the most expensive parts of the device, a lack of reworkability is a costly problem; if the screen assembly were pulled from such a device, the display would be damaged, requiring replacement.

While the present disclosure is directed to a system that can eliminate certain shortcomings noted in this Background section, it should be appreciated that such a benefit is neither a limitation on the scope of the disclosed principles nor of the attached claims, except to the extent expressly noted in the claims. Additionally, the discussion of technology in this Background section is reflective of the inventors' own observations, considerations, and thoughts, and is in no way intended to accurately catalog or comprehensively summarize the art in the public domain. As such, the inventors expressly disclaim this section as admitted or assumed prior art with respect to the discussed details. Moreover, the identification herein of a desirable course of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example configuration of device components with respect to which embodiments of the presently disclosed principles may be implemented;

FIG. 2 is a front view of a portable electronic device having a screen assembly adhered to the device via a border outside of the active area of the display;

FIG. 3 is a cross-sectional side view of the device of FIG. 2 showing adhesion of the screen assembly via a border region outside the active display area;

FIG. 4 is a front view of a portable electronic device having a screen assembly adhered to the device via the active area of the device display in accordance with an embodiment of the disclosed principles;

FIG. 5 is a cross-sectional side view of the device of FIG. 4 showing adhesion of the screen assembly via the active display area itself in accordance with an embodiment of the disclosed principles;

FIG. 6 is another cross-sectional side view of the device of FIG. 4 showing adhesion of the screen assembly via the active display area itself and via a border region of a device lens in accordance with an embodiment of the disclosed principles; and

FIG. 7 is a flowchart illustrating a process in accordance with an embodiment of the disclosed principles.

### DETAILED DESCRIPTION

Before presenting a fuller discussion of the disclosed principles, an overview is given to aid the reader in understanding the later discussion. As noted above, screen assemblies used in modern portable electronic devices require a non-display border region for adhesion of the screen assembly to the host device. This causes the device frontal area to be larger than the display itself requires. At the same time, this inefficiency cannot be cured by adhering the active display region itself to the device housing, since this would prevent rework of the display assembly (i.e., removing it would destroy it).

In an embodiment of the disclosed principles, a high-efficiency mounting system is provided for the lens and display. The described mounting system yields a product having minimal borders outside of the display area while also providing the ability to remove the display assembly without damaging it, allowing reworkability of one of the most expensive parts of the device.

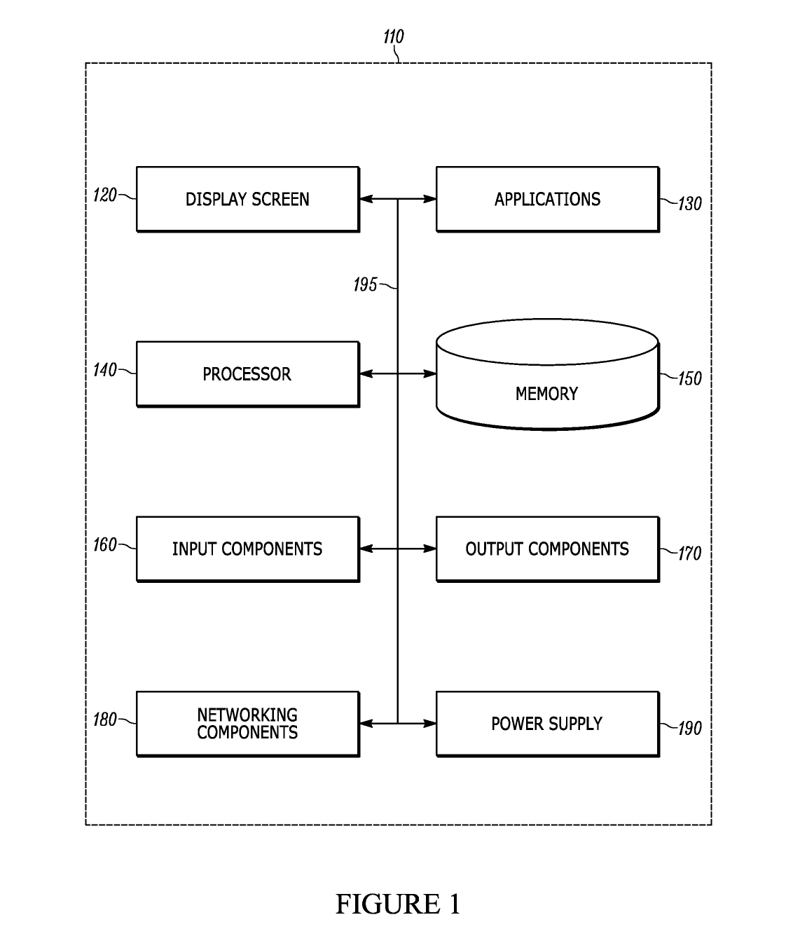

With this overview in mind, and turning now to a more detailed discussion in conjunction with the attached figures, the techniques of the present disclosure are illustrated as being implemented in a suitable computing environment. The following device description is based on embodiments and examples of the disclosed principles and should not be taken as limiting the claims with regard to alternative embodiments that are not explicitly described herein. Thus, for example, while FIG. 1 illustrates an example mobile device within which embodiments of the disclosed principles may be implemented, it will be appreciated that other device types may be used.

The schematic diagram of FIG. 1 shows an exemplary component group 110 forming part of an environment within which aspects of the present disclosure may be implemented. It will be appreciated that additional or alternative components may be used in a given implementation depending upon user preference, component availability, price point, and other considerations.

In the illustrated embodiment, the components 110 include a display screen 120, applications (e.g., programs) 130, a processor 140, a memory 150, one or more input components 160 such as speech and text input facilities, and one or more output components 170 such as text and audible output facilities, e.g., one or more speakers. In an embodiment, the input components 160 include a keyboard on a surface of the device.

The processor 140 may be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device. Such functions may include, for example, interaction among various internal components and storage and retrieval of applications and data to and from the memory 150.

Further with respect to the applications 130, these typically utilize the operating system to provide more specific functionality, such as file system service and handling of protected and unprotected data stored in the memory 150. Although many applications may provide standard or required functionality of the user device 110, in other cases applications provide optional or specialized functionality, and may be supplied by third party vendors or the device manufacturer.

Finally, with respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device having component group 110 may include software and hardware networking components 180 to allow communications to and from the device. Such networking components 180 will typically provide wireless networking functionality, although wired networking may additionally or alternatively be supported.

In an embodiment, a power supply 190, such as a battery or fuel cell, may be included for providing power to the device and its components 110. All or some of the internal components 110 communicate with one another by way of one or more shared or dedicated internal communication links 195, such as an internal bus.

In an embodiment, the device 110 is programmed such that the processor 140 and memory 150 interact with the other components of the device 110 to perform certain functions. The processor 140 may include or implement various modules and execute programs for initiating different activities such as launching an application, transferring data, and toggling through various graphical user interface objects (e.g., toggling through various display icons that are linked to executable applications).

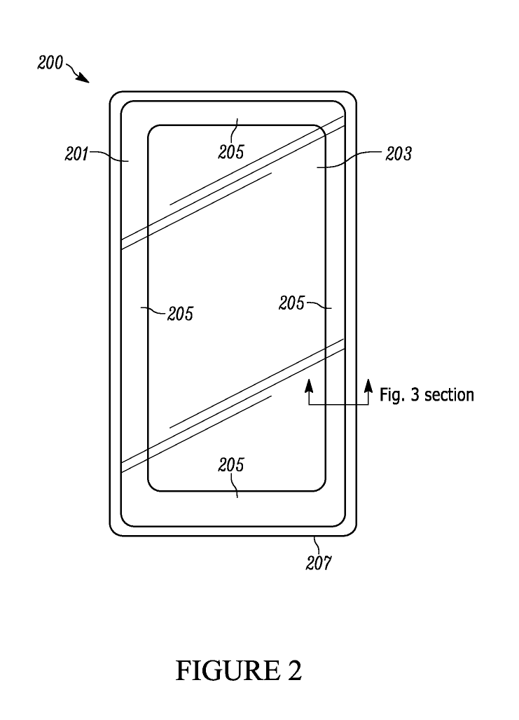

Turning to FIG. 2, this figure presents a front view of a portable electronic device 200 having a screen assembly adhered to the device 200 via a border outside of the active area of the display. More specifically, the illustrated device 200 includes a housing 207 to which is attached a screen assembly. The screen assembly includes a lens 201 attached to a display 203. The lens 201 is transparent, inactive and generally uniform, and serves to retain and protect the underlying display 203.

A border area 205 outside the area of the display 203 is adhered to the housing 207 during device assembly such that the screen assembly (lens 201 and display 203) becomes permanently attached to the housing 207. This construction technique is very effective in making the screen assembly a permanent part of the device. However, the border area 205 represents additional device height and width that provides no display function other than as an adhesive surface. As noted above though, this type of construction is required by current adhesive application methods in order to maintain screen reworkability.

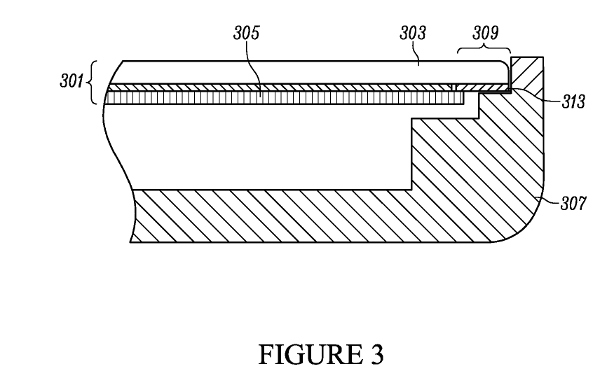

The standard adhesive application method can be seen more clearly in the cross-sectional view of FIG. 3, which provides a cross-sectional side view of the device of FIG. 2, including a detailed view of the adhesive application of the screen assembly. The illustrated view shows the screen assembly 301 including the lens 303, the display 305 and the device housing 307. As can be seen, the display 305 is adhered to the lens 303 via an adhesive layer 313. In turn, the lens 303 is adhered to the device housing 307 at a border region 309 via an adhesive layer 313.

The use of the border region 309 for adhesion requires the lens 303 to have a surface area that extends well beyond the active area of the display 305. However, with conventional adhesive techniques, the display 305 must be adhered in this manner in order to protect the display 305 if the screen assembly 301 is lifted while reworking the device during assembly or while repairing the device after use.

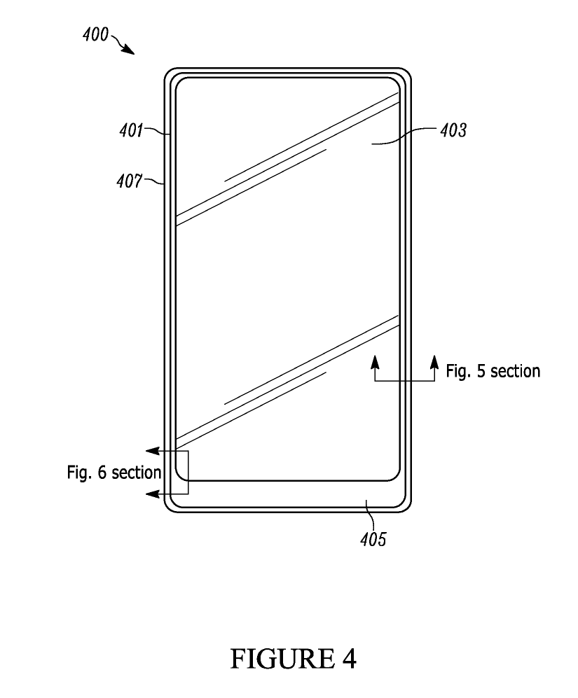

Turning to FIG. 4, this figure provides a front view of a portable electronic device having a screen assembly adhered to the device via the active area of the device display in accordance with an embodiment of the disclosed principles. As can be seen, this assembly technique requires little if any border outside the area of the display 403. A narrow lip of the housing 407 may be used simply to assure lateral and vertical placement of the screen assembly, and to protect the edges of the screen assembly.

The lens 401 is substantially smaller than the lens 205 in FIG. 2, except for a bottom region 405 at the end of the device. This region may contain one or more control buttons or interfaces for user interaction. Moreover, since the display 403 is a touch screen entity in various embodiments of the disclosed principles, the bottom region 405 of the lens 401 may additionally or alternatively serve as a location where a user may grip the device without activating any areas of the display 403.

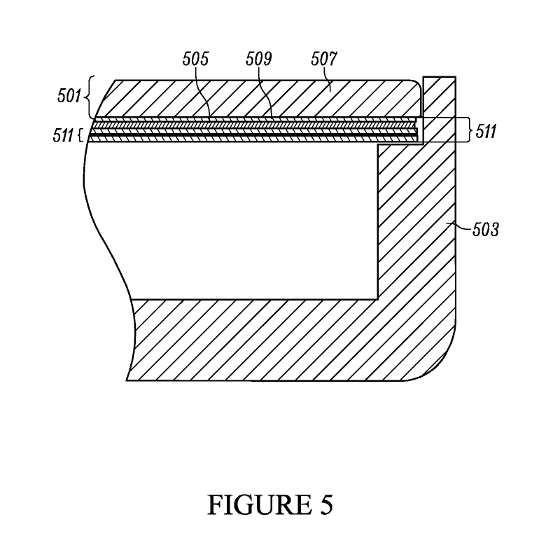

FIG. 5 provides a cross-sectional side view of the device of FIG. 4, taken at a similar general location as the view of FIG. 3. This cross-sectional view shows adhesion of the screen assembly 501 to the housing 503 via the display 505 in accordance with an embodiment of the disclosed principles.

In particular, in this embodiment, the display 505 is adhered to the lens 507 via a lens adhesive layer 509. The screen assembly 501, with the display 505 facing the housing 503, is then affixed to the housing 503 via a multilayer adhesive structure 511. The multilayer adhesive structure 511 also utilizes multiple levels to accommodate different areas around the display. The structure and characteristics of the multilayer adhesive structure 511 will be discussed in greater detail below.

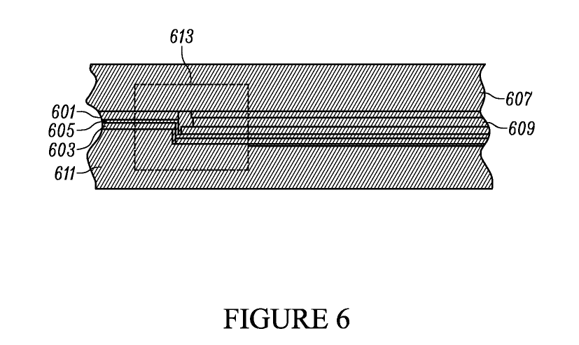

FIG. 6 is a cross-sectional side view of the device of FIG. 4 in a different area and direction from the cross-sectional view of FIG. 5, showing adhesion of the screen assembly via both the display and the lens, by using a multilevel instance of the multilayer adhesive structure 511 in accordance with an embodiment of the disclosed principles. In particular, the illustrated view in FIG. 6 includes a step displacement 613 along the screen edge going from the device lower portion where there is no display to a higher portion where the display exists.

The multilayer adhesive structure 511 comprises a top adhesive layer 601 and a bottom adhesive layer 603, with an intermediate layer 605 between the top adhesive layer 601 and the bottom adhesive layer 603. Although the top adhesive layer 601 and the bottom adhesive layer 603 are shown as discontinuous across the step, it will be appreciated that each such layer may instead be continuous if desired, e.g., for simplicity.

Both the top adhesive layer 601 and the bottom adhesive layer 603 adhere strongly to the intermediate layer 605. Moreover, the top adhesive layer 601 adheres to the lens 607 and the display 609 with a first degree of adhesion. The bottom adhesive layer 603 adheres to the housing 611 with a second degree of adhesion, such that the second degree of adhesion is less than the first degree of adhesion. Degrees of adhesion may be specified, for example, as a force required per unit area to separate one element from another.

Thus, in the installed condition, if the lens 607 is lifted, the weakest adhesion interface is between the bottom adhesive layer 603 and the housing 611. For this reason, the lens and the multilayer adhesive structure remain together, and separate from the housing 611 when the lens 607 is lifted. When the lens 607 is lifted to the point that the separation reaches the step, the intermediate layer 605 enters a tension mode, such that upon further lifting of the lens 607, the intermediate layer 605 pushes the top adhesive layer 601 into compression against the display 609.

At this point, given the strong adhesion between the bottom adhesive layer 603 and the intermediate layer 605, and the lesser adhesion between the bottom adhesive layer 603 and the housing 611, the lifting of the lens 607 results in the lifting of the display 609 and multilayer adhesive structure as well. In this way, the display 609 can be directly in the stack of materials adhered to the housing 611 without being damaged during rework or repair. Moreover, the ability to include the display 609 in the stack of materials adhered to the housing 611 eliminates the need for a display-free border, and allows the display 609 to extend substantially to the edges of the device housing 611.

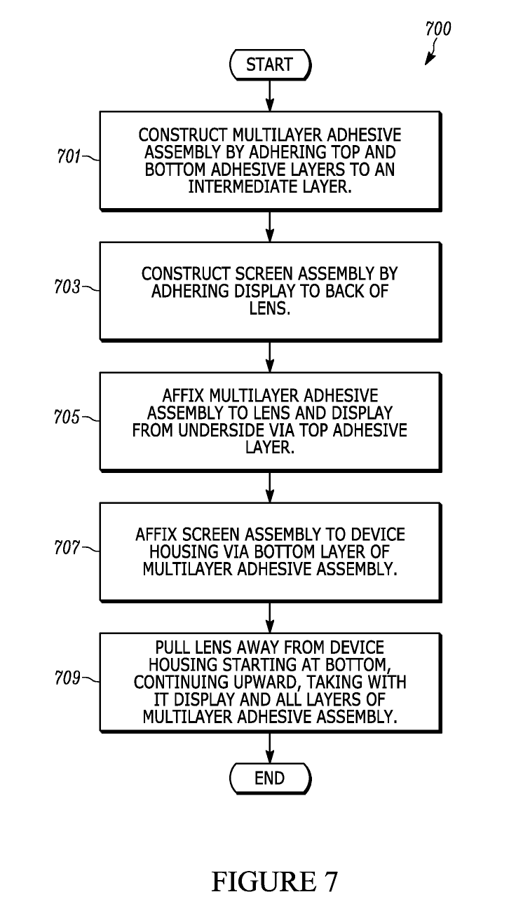

Although various methodologies may be used to create the illustrated assemblies, the flow chart of FIG. 7 shows an example process 700 by which a device screen assembly is affixed to a device housing without the use of adhesive borders, and in such a way as to allow repair and rework of the screen assembly, and subsequently removed for rework.

At stage 701 of the process 700, a multilayer adhesive assembly is constructed by adhering top and bottom adhesive layers to an intermediate layer. The intermediate layer is chosen to exhibit strength in tension, and may be or comprise a stranded polymer, sheet polymer, or similar directional or nondirectional material. The thinness of each layer is about 100 um in an embodiment, but other thicknesses may be used depending upon the materials selected. The adhesive assembly may be shaped to follow just within the perimeter of the screen assembly, and may have one or more gaps in one or both of the top and bottom adhesive layers.

At stage 703 of the process 700, a screen assembly is constructed by adhering a display to the back of a lens, with the display and lens having approximately, though likely not precisely, the same area. Subsequently at stage 705, the multilayer adhesive assembly is affixed to the lens and display from the underside via the top adhesive layer.

The device is completed at stage 707 with the affixing of the screen assembly to the device housing via the bottom layer of the multilayer adhesive assembly. As noted above, the adhesion of the bottom adhesive layer to the device housing is weaker than the adhesion of the bottom layer to the intermediate layer, the adhesion of the intermediate layer to the top layer, and the adhesion of the top layer to the lens in any regions where the top layer contacts the lens. Such regions include a bottom border where the lens covers the device face but where the display does not extend.

If rework of the device is needed with respect to the assembly of the lens and display to the device housing, the process flows to stage 709, wherein the lens is pulled away from the device housing starting at the bottom (where the display does not extend) and continuing upward, taking with it the display and all layers of the multilayer adhesive assembly.

It will be appreciated that systems and methods for device construction have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A portable electronic device comprising:
a device housing;
a three-layer adhesive assembly having a top adhesive layer, an intermediate layer and a bottom adhesive layer; and
a lens assembly including, a device display and a lens; wherein the device display is affixed to an underside of the lens, and wherein the device display is affixed to the top adhesive layer and the lower adhesive layer is affixed to the device housing, the lens including at least one border region wherein the device display does not extend, and wherein the top adhesive layer is affixed to the lens in the at least one border region, the three layer adhesive assembly having a step displacement from the at least one border region to the display.

2. The portable electronic device in accordance with claim 1, wherein the top adhesive layer has a first adhesive strength with which it attaches to the device display and the bottom adhesive layer has a second strength with which it attaches to the device housing, and wherein the first strength exceeds the second strength.

3. The portable electronic device in accordance with claim 1, wherein the display has a display width and the lens has a lens width, and wherein the display width is substantially the same as the lens width.

4. The portable electronic device in accordance with claim 1, wherein one or both adhesive layers include a gap at the location of the step displacement.

5. The portable electronic device in accordance with claim 1, wherein the device housing includes a lip surrounding a periphery of the lens.

6. The portable electronic device in accordance with claim 1, wherein the device housing is coextensive with the lens.

7. The portable electronic device in accordance with claim 1, wherein the device display is touch sensitive.

8. A multilayer screen assembly for a portable electronic device comprising:
a device display;
a lens, wherein the device display is affixed to an underside of the lens; and
a three layer adhesive assembly affixed to the device display for attachment to a device housing, wherein the three layer adhesive assembly includes a top adhesive layer affixed at least to the device display, a lower adhesive layer for affixing the multilayer screen assembly to a device housing and an intermediate layer affixed to both adhesive layers, the lens having at least one border region wherein the device display does not extend, the top adhesive layer being affixed to the lens in the border region and to the device display outside of the border region, such that the three layer adhesive assembly exhibits a step displacement going from the border region to the device display,

9. The multilayer screen assembly in accordance with claim 8, wherein the top adhesive layer has a first adhesive strength with which it attaches to the lens and the device display and the bottom adhesive layer has a second strength with which it attaches to the device housing, and wherein the first strength exceeds the second strength.

10. The multilayer screen assembly in accordance with claim 8, wherein the display has a display width and the lens has a lens width, and wherein the display width is substantially the same as the lens width.

11. The multilayer screen assembly in accordance with claim 8, further including the device housing, and wherein the device housing includes a lip surrounding a periphery of the lens.

12. The multilayer screen assembly in accordance with claim 8, further including the device housing, and wherein the device housing is coextensive with the lens.

13. The multilayer screen assembly in accordance with claim 8, wherein the device display is touch sensitive.

14. The multilayer screen assembly in accordance with claim 8, wherein and wherein one or both adhesive layers includes a gap at the step displacement.

15. A method for affixing a screen assembly to a portable electronic device, wherein the screen assembly includes a lens and a device display affixed to an underside of the lens, wherein the device display is substantially coextensive with the lens except for one or more border regions of the lens, the method comprising:
constructing a multilayer adhesive assembly including a top adhesive layer, an intermediate layer, and a bottom adhesive layer;
affixing the multilayer adhesive assembly to the underside of the device display and, in the one or more border regions, to the lens, such that the three layer adhesive assembly exhibits a step displacement from the border region to the display; and
affixing the screen assembly to a housing of the portable electronic device via attachment of the bottom adhesive layer of the multilayer adhesive assembly to the housing.

16. The method in accordance with claim 15, wherein the top adhesive layer has a first adhesive strength with which it attaches to the lens and the device display and the bottom adhesive layer has a second strength with which it attaches to the device housing, and wherein the first strength exceeds the second strength.

17. The method in accordance with claim 15, wherein the display has a display width and the lens has a lens width, and wherein the display width is substantially the same as the lens width.

18. The method in accordance with claim 15, wherein one or both of the adhesive layers includes a gap at the step displacement.

19. The method in accordance with claim 15, wherein the housing of the portable electronic device includes a lip surrounding a periphery of the lens.

20. The method in accordance with claim 15, wherein the housing of the portable electronic device is coextensive with the lens.
